(19) United States
(12) Patent Application Publication
(10) Pub. No.: US 2017/0118804 A1
(43) Pub. Date: Apr. 27, 2017

(54) Inductive Cosmetic Depotting Device and Method

(71) Applicant: Z PRODUX, Inc, Sherman Oaks, CA (US)

(72) Inventors: Zena Shteysel, Studio City, CA (US); Danny Lamont Green, Van Nuys, CA (US)

(73) Assignee: Z PRODUX, INC, Sherman Oaks, CA (US)

(21) Appl. No.: 14/921,687

(22) Filed: Oct. 23, 2015

(51) Int. Cl. H05B 6/14; H05B 1/02; H05B 6/10; H05B 6/06

(52) U.S. Cl. CPC H05B 6/14; H05B 6/062; H05B 1/0202; H05B 6/10

(57) ABSTRACT

The improved cosmetic depotting device includes an induction coil that selectively heats a conductive cosmetic pan placed on a surface above the induction coil sufficiently to loosen the adhesive bond between the cosmetic pan and the retail package within which it is contained. A microcontroller switches the operating frequency of the induction coil to effect adequate heating of low mass standard cosmetic pans. A retail makeup package is placed on the heating surface, the device is powered on and the heat setting raised until the cosmetic pan adhesive is sufficiently softened to allow removal from the retail packaging. Makeup compounds may also be melted for placement in a chosen cosmetic pan for subsequent placement in a configurable makeup organizer Safe heating and depotting of makeup compounds makes the device ideal for use in a commercial setting, for example, in a kiosk near a department store of a shopping mall.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

Field of the Invention

The present invention relates to an induction heating device and methods for its specialized use with cosmetics and makeup compounds.

Description of Related Art Including Information Disclosed Under 37 CFR 1.97 and 1.98

Cosmeticians typically experience considerable difficulty as they work with different shades and types of makeup. In one hand will often be a makeup brush and in the other hand will be a particular shade of makeup. Unfortunately as the cosmetician needs to apply a different shade it becomes necessary to handle and exchange different makeup containers. Accordingly, holders have been developed that permit the cosmetician to organize and retain a multitude of containers of differing makeup, affording the cosmetician a palette from which to work. However, cosmetic product companies provide the various makeup products in packaging that does not allow ready access to the makeup pans.

Commercial makeup products, for example, eye shadow, foundation, concealer, blush, bronzer compounds, and the like, are typically provided in a retail package that is designed to protect the makeup compound during storage and handling. The retail package typically consists of a metal cosmetic pan containing the makeup compound that is adhesively attached to an outer shell made of plastic or cardboard. A double-sided adhesive tape or glue is utilized during package manufacture to retain the cosmetic pan therein. Therefore, before the pan containing the makeup compound can be added to the cosmetician's palette, it must first be removed from the outer protective shell in a process known as “depotting.”

Simple prying to accomplish depotting is a very poor option for removal because such efforts often result in damage to the pan and/or the contents therein, which may render it unusable. Heat applied externally to the retail package may be used to soften the adhesive, which will allow for easier extraction of the makeup pan. However, current resistive heating devices and methods are difficult to control and can melt or burn the outer retail product packaging and/or the makeup compound, and can burn the hands of the operator. For example, resistive hotplates, irons, blow dryers, an open flame are common methods that are employed for depotting, and each of which are inherently dangerous to some degree.

Inductive cooking devices are known and understood, and have been commonly used for controlled heating of metallic objects like pots and pans. With an inductive heating device an electrically conductive object is heated by electromagnetic induction, which generates eddy currents and magnetic hysteresis losses within the object that causes the heating. However, standard inductive heating devices have a minimum capacity load that must be present over the induction coils for the heating to occur. This minimum capacity load is the minimum amount of metal that must be present for the electromagnetic flux generated by the induction coil to couple with the metal and cause the heating to occur. A typical induction cooktop requires at a minimum a 127 mm (5-inch) in diameter metal pot or pan for the heating effect to occur. Given that standard metal cosmetic pans range between 18.5 mm to 55 mm, insufficient capacity load exists to utilize a common induction cooktop in this regard.

What is needed is a device that allows for even, controllable heating of the makeup pan that avoids this heat related damage. The present invention teaches such a device and methods for its use, and provides yet additional benefits as described herein.

### BRIEF SUMMARY OF THE INVENTION

The invention may be embodied in several forms, including an inductive cosmetic depotting device, the device comprising: a first surface for supporting a retail makeup package containing a cosmetic pan adhesively bonded thereto; and a magnetic induction coil beneath the first surface, the induction coil adapted to inductively heat the cosmetic pan to soften the adhesive bond to allow removal of the cosmetic pan from the retail makeup package. In yet other embodiments of the device the inductance of the induction coil is in the range of 80 μH to 125 μH; the induction coil is driven at a frequency in the range of 22 kHz to 27 kHz; the induction coil is driven at a frequency in the range of 22 kHz to 40 kHz; and/or the induction coil is driven with pulsed DC. Another embodiment comprises: a microcontroller device adapted to selectively control the induction coil operating frequency to effect heating of a cosmetic pan based upon the cosmetic pan size. The microcontroller device may also be further adapted to provide a first setting for heating the cosmetic pan and a second setting for heating a standard induction cookware.

The inductive cosmetic depotting device embodiment also may comprise: a first surface for supporting a cosmetic pan or a lipstick tube; and a magnetic induction coil beneath the first surface, the induction coil adapted to inductively heat the cosmetic pan or lipstick tube to soften a makeup product therein for transfer to another cosmetic pan. In yet other embodiments the inductance of the induction coil is in the range of 80 pH to 125 μH; the induction coil is driven at a frequency in the range of 22 kHz to 27 kHz; the induction coil is driven at a frequency in the range of 22 kHz to 40 kHz; and/or the induction coil is driven with pulsed DC. The device embodiment may also comprise: a microcontroller device adapted to selectively control the induction coil operating frequency to effect heating of a cosmetic pan based upon the cosmetic pan size, and may be further adapted to provide a first setting for heating the cosmetic pan and a second setting for heating a standard induction cookware.

The invention may also be embodied in a method for using the inductive cosmetic depotting device. For example, a method is envisioned with method steps comprising: providing an inductive cosmetic depotting device, the device comprising a first surface for supporting a retail makeup package containing a cosmetic pan adhesively bonded thereto; and a magnetic induction coil beneath the first surface, the induction coil adapted to inductively heat the cosmetic pan to soften the adhesive bond to allow removal of the cosmetic pan from the retail package; inductively heating a first retail makeup package containing a first cosmetic pan to soften an adhesive bond therebetween; and removing the first cosmetic pan from the first retail makeup package. Additional steps in alternate embodiments include assembling the first cosmetic pan in a configurable makeup organizer Yet another embodiment envisions steps comprising: removing at least a portion of a makeup compound from a non-electrically conductive cosmetic pan and placing the removed makeup compound into an empty cosmetic pan to create a second cosmetic pan; inductively heating the second cosmetic pan sufficiently to melt the makeup compound such that the makeup compound substantially conforms to the shape of the second cosmetic pan; and assembling the first and second cosmetic pans in a configurable makeup organizer Another embodiment includes the method steps further comprising: removing at least a portion of a lipstick compound from a lipstick tube and placing the removed lipstick compound into a second cosmetic pan; and inductively heating the second cosmetic pan sufficiently to melt the lipstick compound such that the lipstick compound substantially conforms to the shape of the second cosmetic pan. In yet another embodiment the method steps further comprise: assembling the first and second cosmetic pans in a configurable makeup organizer. The method steps may also be performed as a commercial service for a purchaser of the retail makeup package, or in a shopping mall kiosk for a purchaser of the retail makeup package.

### BRIEF DESCRIPTION OF THE SEVERAL VIEWS OF THE DRAWING(S)

The present invention will be more fully understood by reference to the following detailed description of the preferred embodiments of the present invention when read in conjunction with the accompanying drawings, wherein:

FIG. 1 is a perspective view of a first embodiment of the inductive cosmetic device as described herein;

FIG. 2 is a top-down view of the embodiment of the device with the top surface removed to expose the electrical circuitry and components contained therein;

FIG. 3A is a schematic illustration of the electrical circuitry of the device embodiment, emphasizing the induction coil power and control circuitry;

FIG. 3B is a second schematic illustration of the electrical circuitry of the device embodiment, emphasizing the control panel display and switch circuitry; and

FIG. 4 is a flow diagram of the functionality provided by the device microcontroller.

The above figures are provided for the purpose of illustration and description only, and are not intended to define the limits of the disclosed invention. Use of the same reference number in multiple figures is intended to designate the same or similar parts. Furthermore, if and when the terms “top,” “bottom,” “first,” “second,” “upper,” “lower,” “height,” “width,” “length,” “end,” “side,” “horizontal,” “vertical,” and similar terms are used herein, it should be understood that these terms have reference only to the structure shown in the drawing and are utilized only to facilitate describing the particular embodiment. The extension of the figures with respect to number, position, relationship, and dimensions of the parts to form the preferred embodiment will be explained or will be within the skill of the art after the following teachings of the present invention have been read and understood.

### DETAILED DESCRIPTION OF THE INVENTION

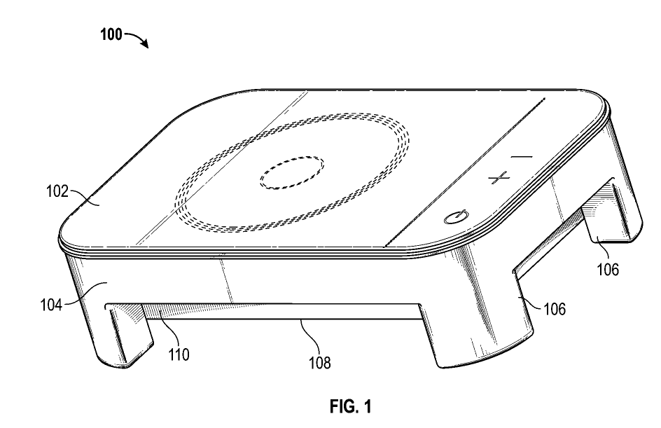

FIG. 1 presents a perspective view of a first embodiment of the device. As shown, the device (100) is rectangular in shape and is portable. The top surface (102) is a first surface for supporting retail makeup packages or other like and unlike items that the user intends to heat, and is supported by a main body (104) that houses the electronic components within. The main body (104) has legs (106) that support the overall device and raise its base (108) to allow for circulation of air thereunder to facilitate cooling. A vent opening (110) in the base allows for the inflow and outflow of ambient air to cool the electronics therein.

The top surface (102) of the embodiment is manufactured from a heat resistant material, namely, ceramic glass because of its strength, appearance, and ability to tolerate heat caused by the object being heated thereon. This surface is non-magnetic and low permittivity such that it freely allows passage of electromagnetic energy therethrough. In other embodiments similar materials may be utilized that exhibit these qualities, and are within the scope of the claims herein.

The main body (104) of the embodiment is manufactured from polymer and is, likewise, heat resistant to withstand the heating of the electrical components mounted therein. A standard polymer for electronic enclosures is utilized, but other embodiments may utilize metal, wood, or the like, which provides adequate rigidity to support the top surface and electronic components that make up the internal circuitry and adequate heat resistance such that the induction coil, power components, and related heat sink temperatures do not burn, melt, or distort the device.

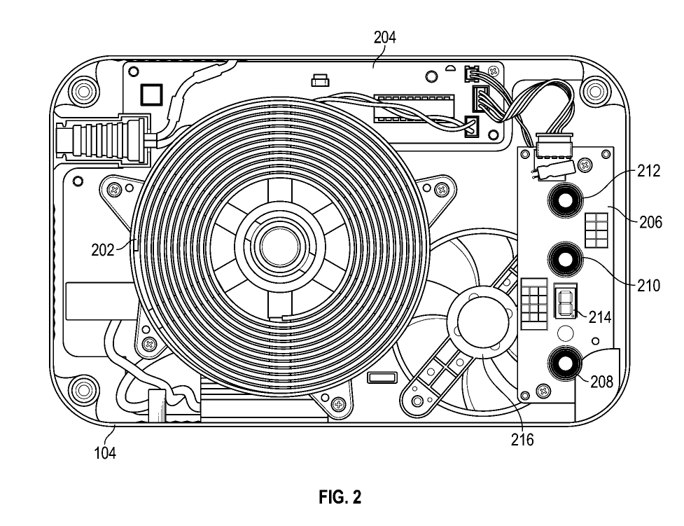

FIG. 2 presents a top-down view of the embodiment of the device with the top surface removed to expose the electrical circuitry and components contained therein. The primary component of the embodiment that causes the inductive heating of the cosmetic pot to occur is the induction coil (202). Standard 120 VAC input voltage is rectified to produce the DC voltages necessary to drive the induction coil (202), with microcontroller control circuitry (204) operating to switch the drive current during operation. An input/output control board (206) provides a user interface for the control circuitry board (204), and includes touch-sensitive switches (208, 210, and 212) and an operational setting display (214). A touch-sensitive switch controller and LED display controller are also present, but are surface mounted on the opposite side of the input/output control board (206) and are not visible in this view. During operation heat is removed from this internal circuitry by a chassis fan (216) that draws ambient air from the exterior of the device and pushes it through the interior of the main body (104).

The induction coil (202) is a 4″ diameter coil of copper conductor wire wound in a spiral fashion such that the flat surface plane that is created by the coil faces the top surface (102) of the device, and is positioned as close to the inner face of the top surface as practicable to ensure maximum coupling of magnetic field to the object undergoing heating. Control of the drive signal for the induction coil (202) emanates from the microcontroller board (204) with which it is attached. Although copper conductor wire is utilized in the present embodiment, other embodiments may utilize other known inductor materials and remain within the scope of the claimed invention. The coil conductors are tightly spaced to concentrate the lines of flux emanating therefrom.

The microcontroller board (204) receives input from the operator through the I/O board (206), upon which an “increase” (210), “decrease” (212), and “power” (208) switch is provided. Operator feedback regarding the device setting is provided through an LED display (214) that presents the current power setting. In the present embodiment the switches (208, 210, and 212) function as capacitance sensing touch keys to afford a smooth device top surface (102). Other embodiments may utilize inductive or mechanical switches or the like, and are within the scope of the claimed invention.

Heat generated by and within the coil, as well as the internal circuitry, is transferred to the ambient air by use of an internal fan (216) and heat sink located below the coil (202) and not visible. Internal air circulates among the internal components and heat sink and passes from the device through the vent openings (110) in the device case.

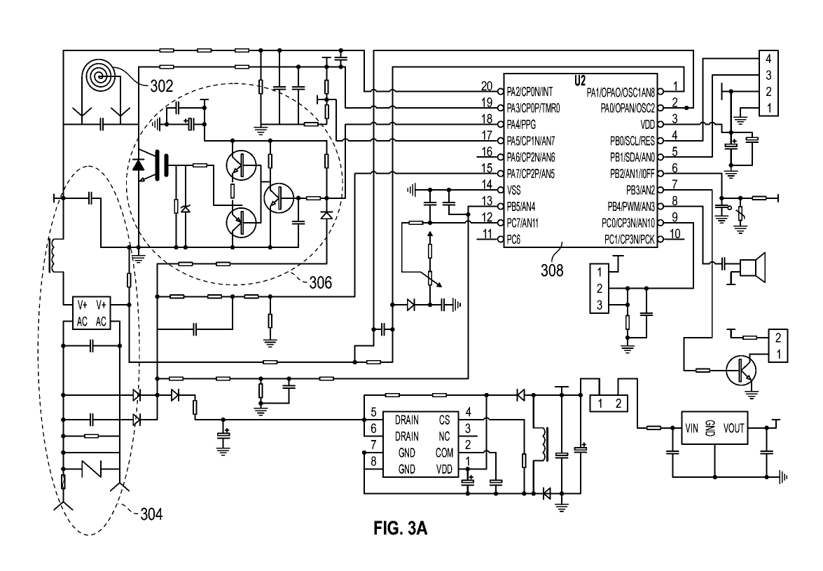

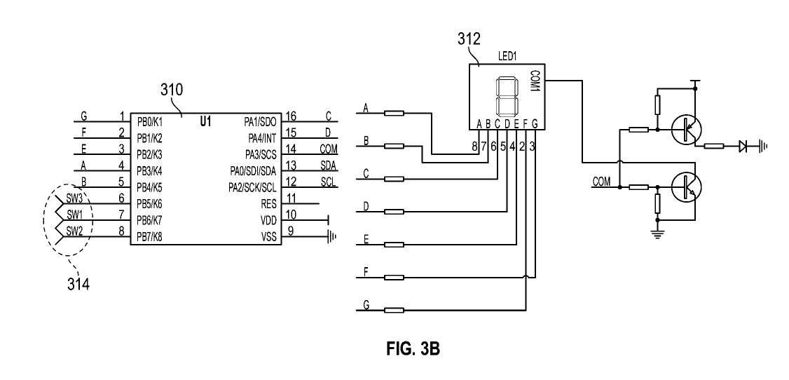

FIG. 3 presents a schematic illustration of the internal electrical circuitry of the device embodiment, emphasizing the induction coil power and control circuitry. As shown in FIG. 3A, input power is AC, which is filtered and rectified (304) to provide DC input power for the induction coil (302). The induction coil (302) DC power is switched by a high-power insulated gate bipolar transistor switching circuit (306) that is driven by the microcontroller (308). It is the pulse frequency generated by the microcontroller (308) that establishes the operating frequency of the inductor (302). In the present embodiment the pulse frequency is between approximately 22 kHz to 27 kHz, which is optimal for the heating of cosmetic pans, which commonly range from between approximately 18.5 mm to 63.5 mm. This operating frequency is indirectly selectable through operation of the user touch switches as described below. Additional circuitry includes a power supply for providing stable IC level voltages and currents for the internal circuitry, an audible operator feedback for button presses and possible overheating alarms.

The microcontroller (308) in the present embodiment is a commercially available programmable RISC (reduced instruction set) microcontroller with adequate onboard RAM and ROM for stored program storage and use. Programming of microcontroller is well understood and is performed using standard compilers that generate machine instructions necessary for the device to perform. Other device embodiments are envisioned utilizing complex instruction set (CISC) microprocessor devices or programmable logic devices capable of executing instructions to provide the described functionality, and are within the scope of the claimed invention.

The portion of the schematic pictured in FIG. 3B presents a second schematic illustration of the electrical circuitry of the device embodiment, emphasizing the control panel display and switch circuitry. Depicted is the touch key controller (310) circuitry on the I/O board (206). The touch key controller (310) in the present embodiment is an 8-bit Touch Key Flash MCU device that is manufactured by HOLTEK™. The “increase” (210), “decrease” (212), and “power” (208) switches on the I/O board are conductive coils of wire that connect with the designated switch inputs (314) to the MCU.

In operation the presence of a user's finger next to one of the conductive coils caused a change in capacitance that is detected by the MCU (310), which decodes the switch and signals the microcontroller (308) of the user's intentions. For example, if the user places a finger near the “increase” (210) coil switch the MCU (310) will detect this and present the appropriate signal to the microcontroller (308) that the user is “pressing” the increase key. The microcontroller (308) code would then execute the appropriate software routines to increase the device power setting. The current device power setting is then displayed on the LED display (312). The device is also capable of detecting and acting on multiple switch presses. For example, if the user places a finger near each of the “increase” (210) and “decrease” (212) coils, the MCU (310) will detect this multiple press and send the appropriate signals to the microcontroller (308) that the user is pressing both “increase” and “decrease” simultaneously, and the microcontroller (308) would then execute the appropriate software routine that, for the present embodiment, would change power modes. Monitoring of the MCU (310) signals may be performed synchronously or asynchronously by the microcontroller (308).

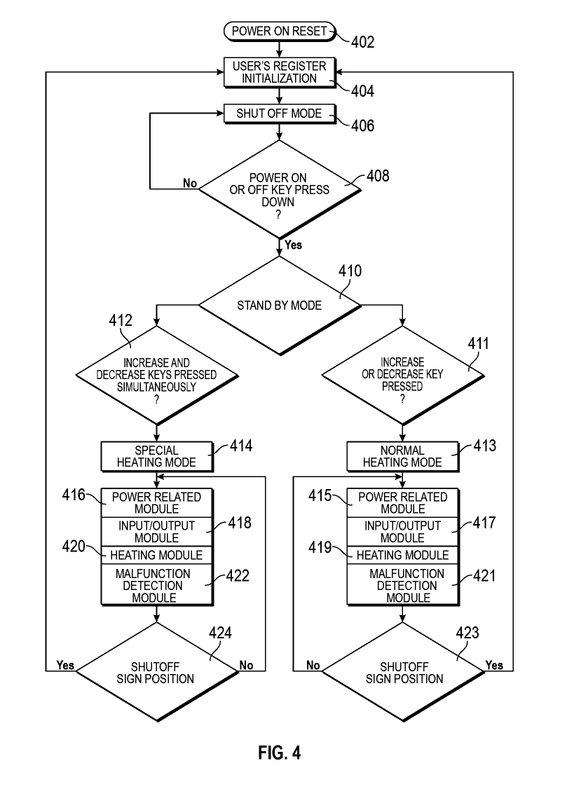

FIG. 4 presents a flow diagram of the high-level functionality provided by the device microcontroller. The microcontroller (308) in this embodiment executes the stored program code to perform the stated functionality. With the device plugged in the microcontroller performs a power on reset (402) in which all registers are first cleared before being initialized (404) to select the proper mode and power level, which is the last mode and power level used. The device then enters a sleep mode (406), which disables the induction coil, and enters into a loop in which it polls the “power” (280) switch. When the device detects the user's finger near the “power” (208) switch the device enters a standby mode (410) and awaits the user's input to begin heating (411 or 412). If the device detects a “press” by the user of the “increase” (210) or the “decrease” (212) key (411), it enters normal heating mode (413). Conversely, if the device detects a “press” by the user of the “increase” (210) and the “decrease” (212) simultaneously (412), it enters a special heating mode (414).

Upon entering the normal heating mode (413) the device performs system initialization functions to prepare for normal heating of a cosmetic pan. Subroutines are executed within the microcontroller (308) in which the power related module is initialized and monitored (415), the I/O module is monitored (417), and the heating module is initialized and monitored (419). A malfunction detection “watch-dog” function (421) is also performed to notify the microcontroller (308) of the presence of a malfunction in a monitored module. Each subroutine continues to execute during normal operation, with the I/O module monitoring function (417) watching for user switch activations. If the user selects the “increase” (210) or “decrease” (212) key, then the power level of the device is changed appropriately. If a malfunction is detected (421) or a “power” (208) switch activation is detected by the I/O module monitoring function (417), then the device enters shutdown mode (423) and returns to the base initialization (404).

In normal heating mode (413) the microprocessor controls the heating module (419) to effect switching of the induction coil (302) at a frequency of between approximately 22 kHz to 27 kHz depending on desired power setting, to effect the heating of cosmetic pans as previously described.

Upon entering the special heating mode (414) the device also performs system initialization functions to prepare for normal heating of a cosmetic pan. Subroutines are executed within the microcontroller (308) in which the power related module is initialized and monitored (416), the I/O module is monitored (418), and the heating module is initialized and monitored (420). A malfunction detection “watch-dog” function (422) is also performed to notify the microcontroller (308) of the presence of a malfunction in a monitored module. Each subroutine continues to execute during special mode normal operation, with the I/O module monitoring function (418) watching for user switch activations. If the user selects the “increase” (210) or “decrease” (212) key, then the power level of the device is changed appropriately. If a malfunction is detected (422) or a “power” (208) switch activation is detected by the I/O module monitoring function (418), then the device enters shutdown mode (424) and returns to the base initialization (404).

In special heating mode (414) the microprocessor controls the heating module (420) to effect switching of the induction coil (302) at a frequency of approximately 20 kHz to 40 kHz depending on desired power setting to effect heating of objects having a substantially greater conductive mass. For example, induction cookware may be utilized and the device may serve as a cooking hot plate to prepare foods. Although the present embodiment utilizes two operating modes (normal and special), other embodiments may utilize additional operating modes or may operate in normal mode only.

Again, in real-world operation the inductive cosmetic depotting device embodiment is first plugged into an AC outlet to obtain power. The power is then switched on using the touch-sensitive controls located on the top surface of the device. Operation of the “+” (“increase”) and “−” (“decrease) touch-sensitive controls alters the power setting, which controls the induction power and the resultant heating. Although the present embodiment has five power settings, with a setting of “1” being the lowest power and “5” being the highest, other embodiments may have fewer or greater number of settings as required by intended usage. For example, if the device will be used for depotting a single type and size of retail packaged cosmetic, it may be possible for the device to have only a single induction setting (either “on” or “off” as required). A more versatile embodiment for use with a broader spectrum of cosmetic types and pan sizes will, understandably, require a greater number of induction settings. Moreover, cosmetics are provided in a broad array of differing types of retail packages, which were assembled on different factory lines and that undoubtedly utilize different types and quantities of adhesive materials to bond the cosmetic pan to the package interior. If little adhesive is used, only a slight amount of inductive heating will be required to successfully depot the cosmetic pan. Conversely, if a very strong adhesive is used, it might be necessary to apply a greater amount and/or duration of heat to soften this strong adhesive. Consequently, a device with a broader spectrum of heat settings will add greater versatility in such situations.

The inductive cosmetic depotting device may be utilized in personal or commercial settings to depot a wide array of cosmetics. In either setting the device is typically used to depot the myriad of cosmetics in an individual's makeup kit to allow for organization in a configurable makeup organizer (makeup palette), for example, the Z Palette® produced and sold by Z Produx, Inc. Moreover, this device embodiment described and claimed herein is supremely useful in many situations. For example, because the heating that occurs with regard to the conductive cosmetic pan is through induction, the heating is uniform and controlled, which prevents or even eliminates damage to the exterior retail packaging within which the pan was adhesively bonded. This prevents distortion of the exterior retail packaging, melting, and outright burning of the packaging material that can (and often does) occur with conventional conductive heating means. This also prevents overheating of the makeup compound. The device may also be used to heat lipstick tubes to allow easy removal of the lipstick and placement into a cosmetic pan for inclusion in a makeup palette.

It is also possible to utilize the graduated heat settings to safely melt cosmetic compounds for transfer to alternate cosmetic pans. For example, it is possible to safely heat a depotted cosmetic pan to soften the remaining makeup compound to allow transfer of the remaining makeup compound to a smaller cosmetic pan. Such transfer will allow for more efficient utilization of the finite space within a makeup organizer.

In a commercial setting it is envisioned that the inductive cosmetic depotting device described and claimed herein may be utilized to provide a unique service for shoppers. For example, a kiosk may be provided in a shopping mall in close proximity to department stores providing makeup products. Shoppers purchasing makeup undoubtedly leave the department store with multiple retail packages of cosmetics, each retail package having excess outer packaging material that, although intended to protect the cosmetic prior to sale, is unnecessary for the consumer at home. The shopper can access the kiosk to have the multiple packages of cosmetics safely depotted using the induction method provided herein. The depotted makeup can then be added to the shopper's existing makeup palette or may be added to a new makeup palette that is purchased by the shopper at the kiosk. Because of the inherent safety of the depotting device, the kiosk can be staffed with an assistant that performs the depotting service or it can be a self-serve kiosk for the shopper's convenience.

The invention may be embodied in other specific forms without departing from the spirit or essential characteristics thereof. The present embodiments are therefore to be considered in all respects as illustrative and not restrictive. Accordingly, the scope of the invention is established by the appended claims rather than by the foregoing description. All changes which come within the meaning and range of equivalency of the claims are therefore intended to be embraced therein. Further, the recitation of method steps does not denote a particular sequence for execution of the steps. Such method steps may therefore be performed in a sequence other than that recited unless the particular claim expressly states otherwise.

We claim:

1. An inductive cosmetic depotting device, the device comprising:
a first surface for supporting a retail makeup package containing a cosmetic pan adhesively bonded thereto; and
a magnetic induction coil beneath the first surface, the induction coil adapted to inductively heat the cosmetic pan to soften the adhesive bond to allow removal of the cosmetic pan from the retail makeup package.

2. The device of claim 1, wherein the inductance of the induction coil is in the range of 80 μH to 125 μH.

3. The device of claim 1, wherein the induction coil is driven at a frequency in the range of 22 kHz to 27 kHz.

4. The device of claim 1, wherein the induction coil is driven at a frequency in the range of 22 kHz to 40 kHz.

5. The device of claim 1, wherein the induction coil is driven with pulsed DC.

6. The device of claim 1 further comprising:
a microcontroller device adapted to selectively control the induction coil operating frequency to effect heating of a cosmetic pan based upon the cosmetic pan size.

7. The device of claim 6, wherein the microcontroller device is further adapted to provide a first setting for heating the cosmetic pan and a second setting for heating a standard induction cookware.

8. An inductive cosmetic depotting device, the device comprising:
a first surface for supporting a cosmetic pan or a lipstick tube; and
a magnetic induction coil beneath the first surface, the induction coil adapted to inductively heat the cosmetic pan or lipstick tube to soften a makeup product therein for transfer to another cosmetic pan.

9. The device of claim 8, wherein the inductance of the induction coil is in the range of 80 μH to 125 μH.

10. The device of claim 8, wherein the induction coil is driven at a frequency in the range of 22 kHz to 27 kHz.

11. The device of claim 8, wherein the induction coil is driven at a frequency in the range of 22 kHz to 40 kHz.

12. The device of claim 8, wherein the induction coil is driven with pulsed DC.

13. The device of claim 8 further comprising:
a microcontroller device adapted to selectively control the induction coil operating frequency to effect heating of a cosmetic pan based upon the cosmetic pan size.

14. The device of claim 13, wherein the microcontroller device is further adapted to provide a first setting for heating the cosmetic pan and a second setting for heating a standard induction cookware.

15. A method for depotting cosmetics, the method steps comprising:
providing an inductive cosmetic depotting device, the device comprising a first surface for supporting a retail makeup package containing a cosmetic pan adhesively bonded thereto; and a magnetic induction coil beneath the first surface, the induction coil adapted to inductively heat the cosmetic pan to soften the adhesive bond to allow removal of the cosmetic pan from the retail package;
inductively heating a first retail makeup package containing a first cosmetic pan to soften an adhesive bond therebetween; and
removing the first cosmetic pan from the first retail makeup package.

16. The method of claim 15, the method steps further comprising:
assembling the first cosmetic pan in a configurable makeup organizer

17. The method of claim 15, the method steps further comprising:
removing at least a portion of a makeup compound from a non-electrically conductive cosmetic pan and placing the removed makeup compound into an empty cosmetic pan to create a second cosmetic pan;
inductively heating the second cosmetic pan sufficiently to melt the makeup compound such that the makeup compound substantially conforms to the shape of the second cosmetic pan; and
assembling the first and second cosmetic pans in a configurable makeup organizer

18. The method of claim 15, the method steps further comprising:
removing at least a portion of a lipstick compound from a lipstick tube and placing the removed lipstick compound into a second cosmetic pan; and
inductively heating the second cosmetic pan sufficiently to melt the lipstick compound such that the lipstick compound substantially conforms to the shape of the second cosmetic pan.

19. The method of claim 18, the method steps further comprising:
assembling the first and second cosmetic pans in a configurable makeup organizer.

20. The method of claim 15, wherein the method steps are performed as a commercial service for a purchaser of the retail makeup package.

21. The method of claim 15, wherein the method steps are performed in a shopping mall kiosk for a purchaser of the retail makeup package.
